(19) United States
(12) Patent Application Publication
(10) Pub. No.: US 2006/0184651 A1
(43) Pub. Date: Aug. 17, 2006

(54) Architecture for general purpose trusted virtual client and methods therefor

(76) Inventor: Srikanthan Tirnumala, San Jose, CA (US)

Correspondence Address: IPSG, P.C., P.O. BOX 700640, SAN JOSE, CA, 95170-0640, US

(21) Appl. No.: 11/352,504

(22) Filed: Feb. 10, 2006

Related U.S. Application Data
(60) Provisional application No. 60/652,531, filed on Feb. 11, 2005.

(51) Int. Cl. G06F 9/44; G06F 15/177; G06F 15/16

(52) U.S. Cl. 709/220; 717/168; 709/229

(57) ABSTRACT

A method of installing a software patch on a device is disclosed. The method includes coupling the device to a network, the network including a set of network resources, the device further including a virtual client and a first software application. The method also includes determining if the device includes the software patch. The method further includes launching a second software application on a server, wherein the second application is substantially similar to the first application, and a user interface to the second application is displayed in the virtual client. The also includes opening a data file with the second application; if needed, installing the software patch on the device; and launching the first software application, wherein the first software application is configured to read the data file.

### BACKGROUND OF THE INVENTION

The present invention relates in general to personal communication systems. More particularly, the present invention relates to an architecture for general purpose trusted virtual client and methods therefore.

Information technology has been tremendously beneficial in today's dynamic marketplace. By substantially increasing the connectivity of individuals and businesses to each other, as well as to information and intelligence, decisions can be quickly made and rapidly executed, anywhere in the world and any time of day.

But as the technology has propagated throughout the enterprise, it has also increased in complexity. Many modern business must deal with various operating systems, running thousands of applications, each different than the other. For example, businesses often need to patch their applications of operating systems. A patch is an actual piece of object code that is inserted into (patched into) an executable program to fix to a program bug. Since many software applications and operating systems are very complex, and hence programmatically very large (e.g., millions of lines of programming code), each may have hundreds or even thousands of patches available. Often, on any given computer, only a fraction of the total patches are installed.

A common reason to patch an application is to correct a potential or actual security problem. The modern Internet has provided malicious parties a very effective channel to threaten companies through their computers. Threats on the Internet mirror those in the actual world: theft, invasion of privacy, property damage, etc. Since networks are by design efficient at transferring information, and since the same networks are themselves connected through the Internet, online attacks can propagate very quickly throughout the world. Common attacks include viruses or worms.

A virus is malicious software that attaches itself to other software. For example, a patched software application in which the patch's algorithm is designed to implement the same patch on other applications, thereby replicating. A worm is a malicious stand-alone application which is often designed to propagate through a network, rather than just a single computer.

Patch management is the process of updating applications and operating systems with the latest security patches. It generally involves first determining what patches are missing, second determining which of these missing patches must be installed, third acquiring the required patches, testing the required patches to insure that they function correctly, and forth, deploying the required patches to the computers.

Some companies will segregate or quarantine computers from the rest of their internal network until the proper patches are installed. Vendors, such as Cisco and Microsoft, have proposed patch management systems that control network access and enforce patch compliance, in order to increase security and mitigate the propagation of viruses through the network.

Referring now to FIG. 1, a simplified network with a compliance-based patch management control system is shown. Initially, computer 102 attempts to access network resources 110 (e.g., printers, email, etc.) through network 106, such as a company intranet. Patch management & compliance server 108 is notified of the connection by trusted network 106 and first determines if computer 102 is a known computer or an unknown computer.

If computer 102 is unknown, patch management & compliance server 108 further determines if network access should be completely denied, or if the computer should be brought into compliance.

If computer 102 is known, patch management & compliance server 108 determines the appropriate policies to apply. For example, a traveling salesperson may require a CRM patch, whereas a non-sales employee connecting through a VPN would not need the same patch.

Next, patch management & compliance server 108 scans computer 102 for vulnerabilities as defined by the appropriate security policies. If vulnerabilities are subsequently found, or if further patches are needed, computer 102 is placed into a quarantine role, with access only to quarantine network 104. Computer 102 is subsequently cleaned and then is re-scanned. Once compliant, computer 102 is granted access to trusted network 106 with privileges determined by a pre-defined user role.

However, since the process of making a computer client compliant may be lengthy, employee productivity may be substantially affected. That is, the employee's computer is unavailable during the time that compliance is verified. For example, some operating system patches may take over an hour to install, often requiring a virus scan and a system reboot. In addition, mobile employees may be subjected to the compliance procedure several times during the day, as they periodically access the network through a VPN (virtual private network), such as with a traveling salesperson who sporadically checks his email. Subsequently, many companies will not enforce compliance before granting network access, potentially increasing vulnerability to attacks.

In view of the foregoing, there is desired an architecture for a general purpose trusted virtual client and methods therefore.

### SUMMARY OF THE INVENTION

The invention relates, in one embodiment, to a method of installing a software patch on a device. The method includes coupling the device to a network, the network including a set of network resources, the device further including a virtual client and a first software application. The method also includes determining if the device includes the software patch. The method further includes launching a second software application on a server, wherein the second application is substantially similar to the first application, and a user interface to the second application is displayed in the virtual client. The also includes opening a data file with the second application; if needed, installing the software patch on the device; and launching the first software application, wherein the first software application is configured to read the data file.

The invention relates, in another embodiment, to an apparatus for installing a software patch on a device. The apparatus includes means of coupling the device to a network, the network including a set of network resources, the device further including a virtual client and a first software application. The method also includes means of determining if the device includes the software patch. The method further includes means of launching a second software application on a server, wherein the second application is substantially similar to the first application, and a user interface to the second application is displayed in the virtual client. The method also includes means of opening a data file with the second application; if needed, means of installing the software patch on the device; and means of launching the first software application, wherein the first software application is configured to read the data file.

These and other features of the present invention will be described in more detail below in the detailed description of the invention and in conjunction with the following figures.

### BRIEF DESCRIPTION OF THE DRAWING

The present invention is illustrated by way of example, and not by way of limitation, in the figures of the accompanying drawings and in which like reference numerals refer to similar elements and in which:

FIG. 1 shows a simplified network with a compliance-based patch management control system;

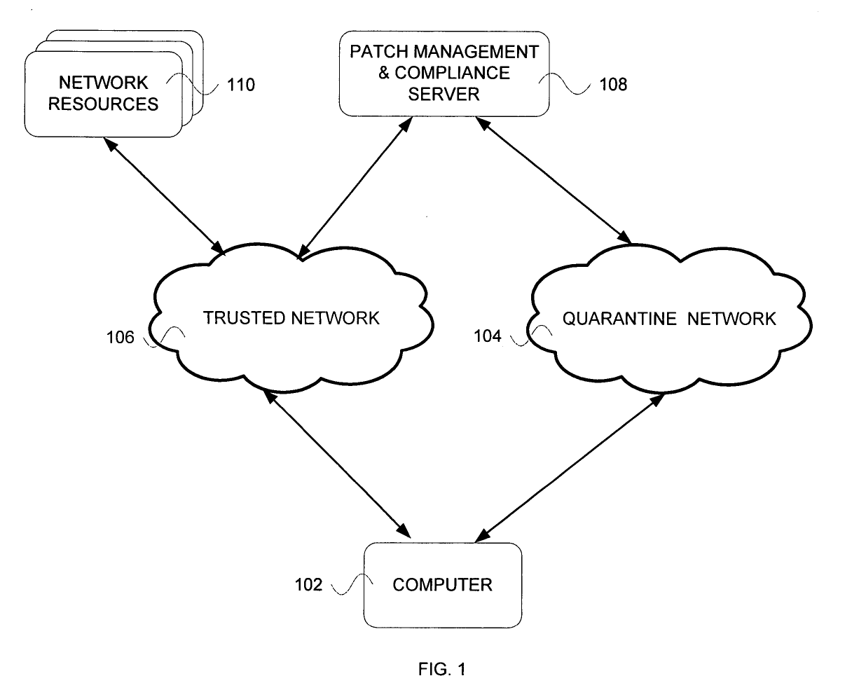

FIG. 2 shows a simplified network diagram in which a trusted virtual client employed with a compliance-based patch management control system, according to one embodiment of the invention;

FIG. 3 shows a simplified diagram of a flow in a LAN or VPN environment and mobile computers, according to one embodiment of the invention;

FIG. 4 shows a simplified diagram of thin client key protection, according to one embodiment of the invention;

FIG. 5 shows a simplified diagram of multi-campus, according to one embodiment of the invention;

FIG. 6 shows a simplified diagram of patch distribution, according to one embodiment of the invention;

FIG. 7 shows a simplified diagram in which a trusted virtual client user interface is invoked on a client device, according to an embodiment of the invention; and

FIG. 8 shows a simplified method of installing a software patch on a device, according to an embodiment of the invention.

### DETAILED DESCRIPTION OF THE PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. The features and advantages of the present invention may be better understood with reference to the drawings and discussions that follow.

In accordance with one embodiment of the present invention, a general purpose trusted virtual client architecture is employed.

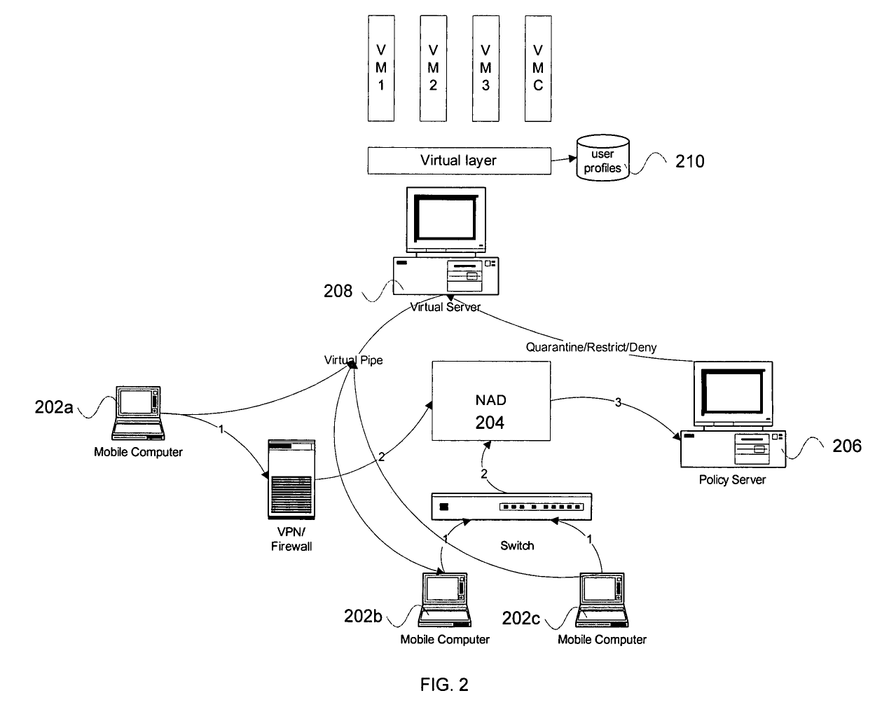

Referring now to FIG. 2, a simplified network diagram is shown in which a trusted virtual client is employed with a compliance-based patch management control system, according to one embodiment of the invention. Initially, NAD 204 (network access device with compliance-based patch management control) categorizes the network access privileges for each client 202a-c as deny, restrict or quarantine, based on a set of pre-defined business policies that are stored on policy server 206.

In non-obvious way, NAD 204 authenticates each client 202a-c, and subsequently creates a virtual framework for each client 202a-c, in which a user may continue to use applications and network resources during the compliance verification period. In an embodiment, client 202a-c may be either a wired (e.g., Ethernet, ATM, etc.) or a wireless client (e.g., 802.11b-g, Bluetooth, etc.). In general, each client 202a-c may further reside in an environment, or connect from a source, that may be either contaminated (e.g., virus, Trojan, etc.) or is otherwise un-trusted or non-compliant with an established security policy.

In an embodiment, NAD 204 may provide the virtual framework for each client 202a-c only during the compliance verification period, after which time the user may access the application or network resource through client 202. For example, a pool of application licenses may be reserved only for use during the compliance verification period, after which time the license may be reused for a different client 202. In another embodiment, NAD 204 may provide the virtual framework for each client 202a-c beyond the compliance verification period. For example, a user may use the virtual framework for an entire application session, avoiding the need to locally instantiate the application on client 202.

In one embodiment, the virtual framework may consist of a trusted virtual client on each client 202 that provides a graphical user interface to a virtual machine [not shown] running on virtual server 208. In general, during the compliance verification period, the virtual machine provides the user with access to a secure operating system and to the particular applications that are normally used by the user on client 202 (i.e., browser, email client, word processor, etc.). In addition, the trusted virtual client is further configured with the credentials, loaded from user profile database 210, that were established when the client user was first created or when the user last connected to the network successfully.

Subsequently, although the trusted virtual client may be programmatically separate from any potentially compromised applications and operating system on client 202, the user is still generally able to access local data files (i.e., email files, general data files, bookmarks, etc.). Subsequently, the connection between the trusted virtual client and virtual server 208 may comprise a first tunnel (i.e., TCPIP tunnel, etc.) In addition, a second tunnel may be created from the trusted virtual client to NAD 204 in order to remediate any problems on client 202a-c through patch updates and virus scans.

In general, after successful remediation, NAD 204 permits client 202a-c access to the trusted network [not shown] and to any appropriate network resources. Each user's profile may then be synchronized between client 202a-c and the user profile database 210 on virtual server 208. The user is then transitioned from the trusted virtual client to the native operating system and applications on client 202a-c, in the same state as previously existed on the trusted virtual machine (i.e., open applications, window size and location, mouse position, open files, etc.), and the trusted virtual client is de-commissioned.

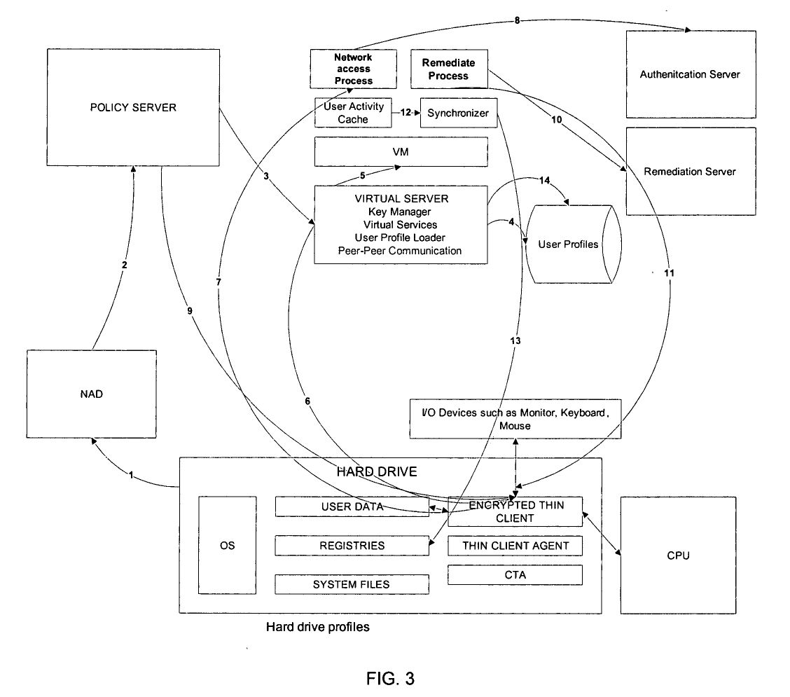

Referring now to FIG. 3, a simplified diagram of a flow in a LAN or VPN environment and mobile computers is shown, according to one embodiment of the invention. Initially at step 1, client connects to the network using CTA, and may be subsequently detected by a router or VPN firewall with a NAD. Next at step 2, the NAD forwards the client request to a security policy server, which subsequently communicates with the client CTA to determine the state of the client. In addition, the NAD determines whether the client should be in one of the following modes:

a. Permit: the client is fully compliant device and can be admitted to the network;

b. Deny: the client is non-compliant with the security policy of the network and the cause for his non-compliancy is not fully known (the client remains in deny mode until the proper remediation is determined and performed);

c. Quarantine: the client is non-compliant and can be made compliant by performing some remediation procedures; and,

d. Restrict: the client is put in restrict mode based on the user privileges and company policy.

For example, if the security policy were to indicate either quarantine, deny or restrict due to some remediation services needed in the client machine, then the policy server may trigger a message to the virtual server, indicating the state of the client and type of services recommended for such user.

At step 4, the virtual server may then connect to the user profile database for the user and load the user profiles that were prevalent when the user last connected to the network successfully. At step 5, after fetching the user database the virtual server may launch a virtual machine with the profile fetched from the user network access database. At step 6, the virtual server may also communicate with the client to secure the connection between the client and server. This process may involve creating a secured tunnel and key exchanges to decrypt the thin client on the client side.

At step 7, the virtual server may start launching the network access process on the virtual machine so that the user can get authenticated. At step 8, network access process may communicate with the authentication server to get the user authenticated with user name and password. At step 9, the virtual server in conjunction with the policy server may then indicate that the client device is in conditional permit mode. At this point, the thin client (trusted virtual client) running on the client machine would have created restrictions to all the system files and folders residing on the machine and would only provide hard drive access to the virtual machine for user related data.

At step 10, because the client is in quarantine, deny or restrict mode, the virtual server may then launch a remediation process on the trusted virtual machine. This remediation process would communicate with the remediation server and subsequently fix the problem on the client, typically within a few seconds to tens of minutes. At step 11, the remediation process would also talk to an agent on the trusted virtual machine to resolve the issues such as updates, patches and spyware/adware deletions.

At step 12, in the mean time, the user may have continued using his user data on the hard drive and user profiles and application on the virtual machine to perform his/her activities on the network seamlessly. All these activities and profile changes due to remediation may be logged in a user activity cache. At step 13, once the remediation process is complete, the user activity cache may be updated on to the synchronizer module on the virtual machine. This module communicates with thin client to update the profiles on the client hard drive.

At step 14, then the virtual machine in conjunction with the virtual server may then update the user profiles and latest permit privileges to the user profile database for subsequent use. And finally at step 15, the client is transitioned from a virtual machine environment to a client based network login.

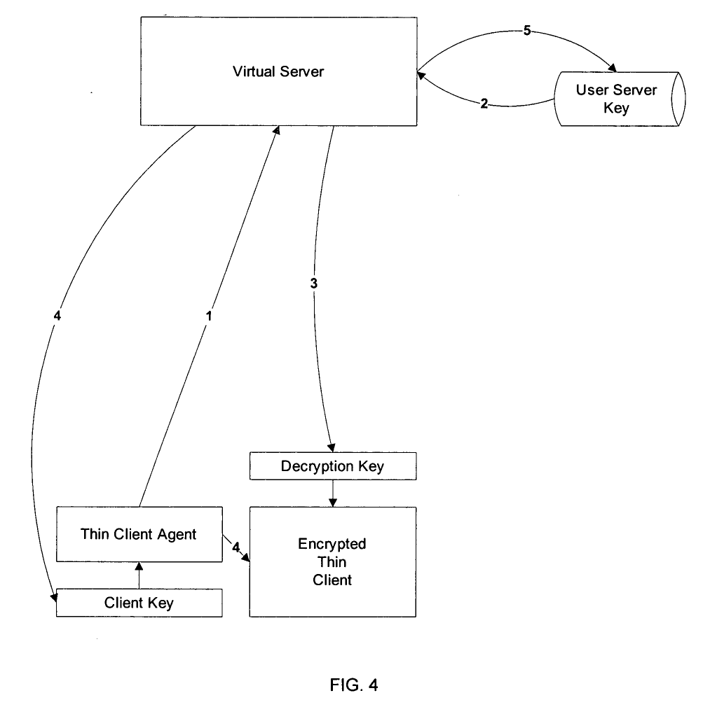

Referring now to FIG. 4, a simplified diagram of thin client key protection is shown, according to one embodiment of the invention. At step 1, a thin client agent (trusted virtual client) running on the client communicates with the virtual server and provides the client key that was provided by the virtual server during previous login. At step 2, the virtual server generates a server key which may subsequently be used to verify the thin client agent against the user profile database.

At step 3, the virtual server provides a decryption key to the thin client agent that may subsequently be used to decrypt the thin client software and allow the client protocol to run on the client machine. The client protocol may have the ability to provide directory list to the virtual machine, and may also be capable of creating virtual tunnels between the client and the virtual machine for network access and remediation of the client software, upgrades etc. At step 4, during logout, the virtual server may generate a new client and server key pair that may be maintained in the user profile database for next use.

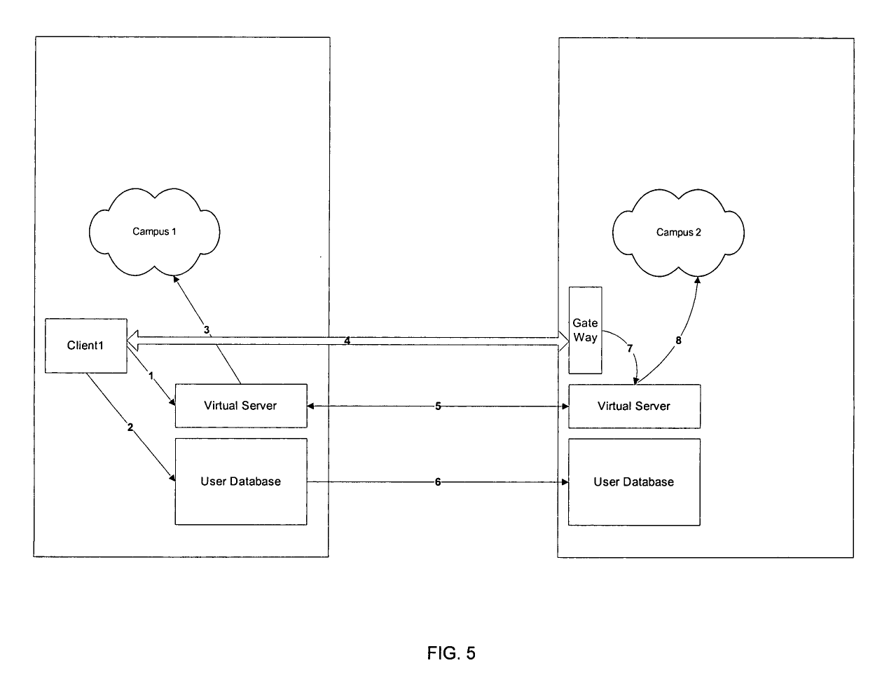

Referring now to FIG. 5, a simplified diagram of multi-campus environment is shown, according to one embodiment of the invention. At step 1, client 1 in campus 1 logs on to the virtual server. At step 2, the virtual server database is updated with the new client profile and new user profile. At step 3, client 1 is connected to the campus 1 network either in permit or conditional permit in campus 1. At step 4, client 1 may then connect to network in campus 2 that may have elevated levels of security policy. At step 5, the virtual server in campus 2 would communicate with virtual server on campus 1, to exchange user profile database to understand the compliancy to the security policy of campus 2. At step 6, the virtual server may then freeze the client 1 machines existing user profiles and invoke the user profile associated with campus 2. At step 7, client 1 connects through the virtual server to the campus 2 network.

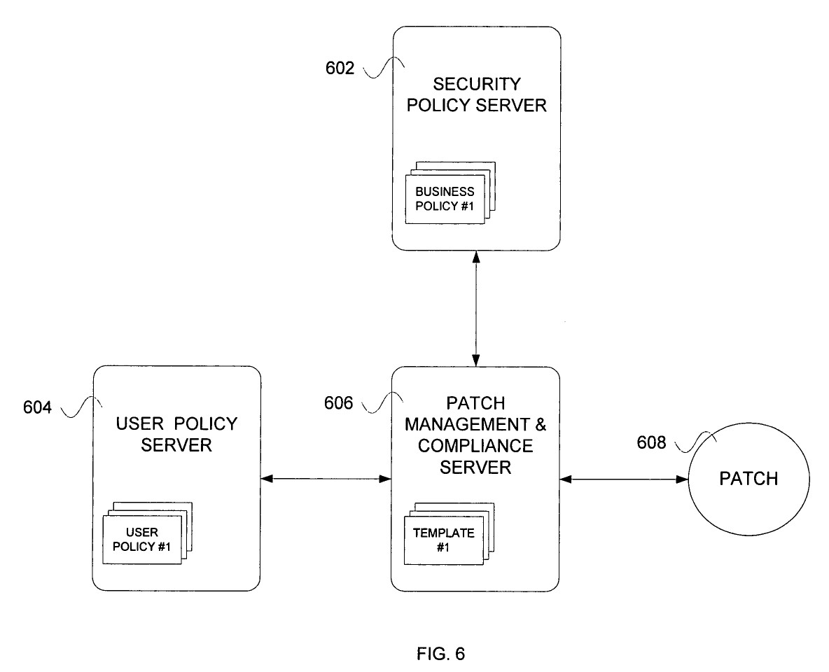

Referring now to FIG. 6, a simplified diagram of patch distribution is shown, according to one embodiment of the invention. In general, compliance-based patch management control server 606 may be coupled to security policy server 602 and to user policy server 604. Security policy server 602 may further include a set of business policies, while user policy server 602 may include a set of user policies. In one embodiment, once a client [not shown] is placed in a quarantine, deny or restrict mode, compliance-based patch management control server 606 launches a remediation process in which a particular patch 608 is transmitted to the client [not shown] based on the set of business polices and the set of user policies.

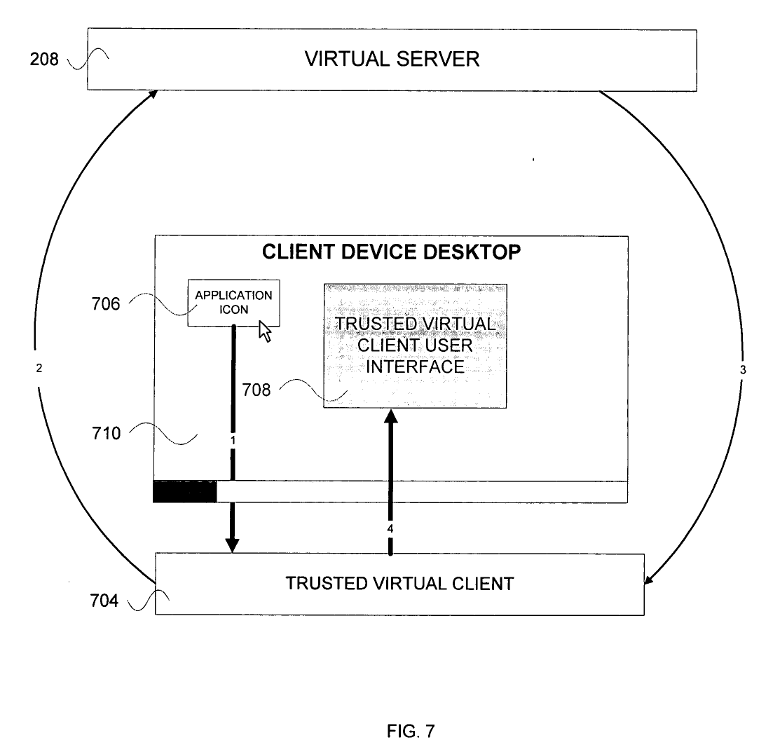

Referring now to FIG. 7, a simplified diagram in which a trusted virtual client user interface is invoked on a client device, according to an embodiment of the invention. As previously described, once the client device [not shown] is attached to the network, NAD 204 determines if access to the network is authorized, based on a set of pre-defined business policies. If such authorization exists, trusted virtual client 704 is invoked for use by the user on the client device during the compliance verification period. Consequently, if the user invokes an application (e.g., email client, browser, word processor, etc.) by selecting an application icon on client device desktop 706, that selection is intercepted by trusted virtual client 704 at step 1.

Next, at step 2, trusted virtual client instructs with virtual server 208 to create a virtual machine [not shown] for the client device, including an instantiation of the requested application. Next, at step 3, virtual server 208 communicates with trusted virtual client 704 that the virtual machine and application are ready. Finally, at step 4, trusted virtual client user interface 708 is displayed on the client desktop 710 ready for use by the user. In an embodiment, trusted virtual client user interface 708 appears to the user as the previous client desktop 710. That is, the user may be effectively unaware that trusted virtual client user interface 708 has even been opened. In an embodiment, trusted virtual client user interface 708 may display a web browser window with a web based GUI framework. In an embodiment, trusted virtual client user interface 708 may display a client application based GUI framework.

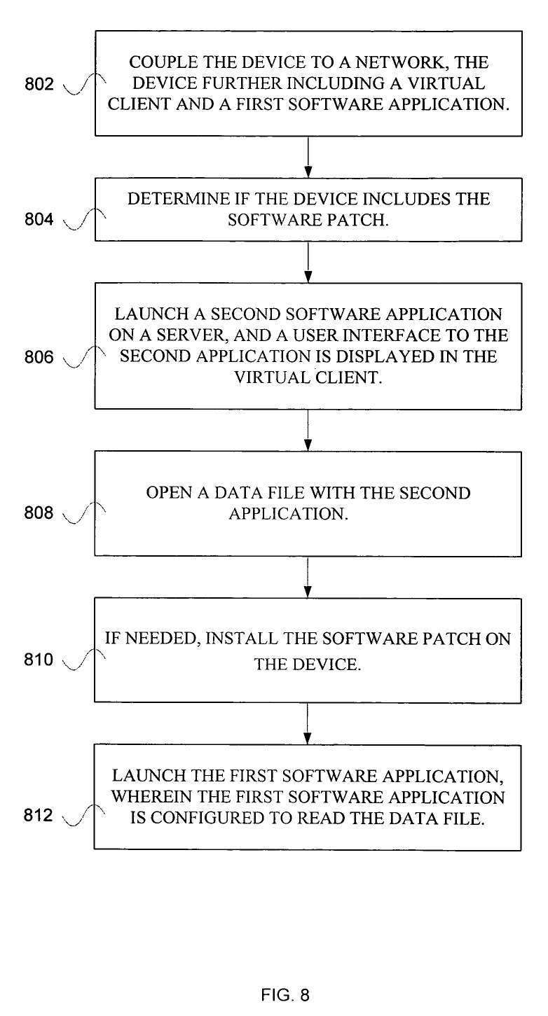

Referring now to FIG. 8, a simplified method of installing a software patch on a device is shown, according to an embodiment of the invention. Initially, at 802, the device (e.g., laptop, desktop, wireless device, etc.) is coupled to a network, the network including a set of network resources (e.g., printers, email, etc.), the device further including a virtual client and a first software application (e.g., email client, word processor, browser, etc.). In an embodiment, the client is a VNC virtual client. In an embodiment, the client is a Citrix client.

Next, at 804, a determination is made if the device includes the software patch. For example, the antivirus program may not have the latest virus signatures installed, or the email client may need to have a security bug fixed. Next, at 806, a second software application is launched on a server, wherein the second application is substantially similar to the first application, and a user interface to the second application is displayed in the virtual client on the device. Typically, the virtual client is in a sandbox, with limited access to device resources (e.g., local hard drive, etc.) in order to reduce the chance of a virus or other malicious application from infecting the network.

Next, at 808, a data file is opened with the second application. In an embodiment, the data file is located on the device. In an embodiment, the data file is located somewhere on the network other than the device. Next, at 810, if needed, the software patch is installed on the device. Finally, at 812, the first software application is launched, wherein the first software application is configured to read the data file. For example, a user may read his emails in the virtual client while the software patch is installed. After installation, the user may then continue to read his emails on the locally installed email client. Any modifications that the user may have made in the virtual client (e.g., deleting emails, moving emails to particular folders, etc.) may then be reflected in the locally installed email client.

While this invention has been described in terms of several preferred embodiments, there are alterations, permutations, and equivalents which fall within the scope of this invention.

Advantages of the invention include an architecture for a general purpose trusted virtual client and methods therefore. Additional advantages include enhanced productivity and lower TCO.

Having disclosed exemplary embodiments and the best mode, modifications and variations may be made to the disclosed embodiments while remaining within the subject and spirit of the invention as defined by the following claims.

What is claimed is:

1. A method of installing a software patch on a device, comprising:
coupling said device to a network, said network including a set of network resources, said device further including a virtual client and a first software application;
determining if said device includes said software patch;
launching a second software application on a server, wherein said second application is substantially similar to said first application, and a user interface to said second application is displayed in said virtual client;
opening a data file with said second application;
if needed, installing said software patch on said device;
launching said first software application, wherein said first software application is configured to read said data file.

2. The method of claim 1, further including the step of restricting access to said set of network resources, after said step of coupling said device to a network.

3. The method of claim 2, further including the step of allowing access to said set of network resources, after said step of if needed, installing said software patch on said device.

4. The method of claim 3, wherein said virtual client is coupled to said server using a TCPIP tunnel.

5. The method of claim 4, further including the step of authentication a user of said device.

6. The method of claim 5, further including the step of closing said second software application, after said step launching said first software application.

7. The method of claim 6, wherein said first application is prohibited from accessing a set of files on said device.

8. The method of claim 7, wherein said step of launching a second software application on a server includes sending a decryption key to said virtual client.

9. The method of claim 8, wherein a change to said data file by said second application is communicated to said first application.

10. The method of claim 9, wherein said user interface of said virtual client is one of a browser window, a web-based GUI framework, and a client application-based GUI framework.

11. An apparatus for installing a software patch on a device, comprising:
means of coupling said device to a network, said network including a set of network resources, said device further including a virtual client and a first software application;
means of determining if said device includes said software patch;
means of launching a second software application on a server, wherein said second application is substantially similar to said first application, and a user interface to said second application is displayed in said virtual client;
means of opening a data file with said second application;
if needed, means of installing said software patch on said device;
means of launching said first software application, wherein said first software application is configured to read said data file.

12. The apparatus of claim 1 1, further including means of restricting access to said set of network resources.

13. The apparatus of claim 12, further including means of allowing access to said set of network resources.

14. The apparatus of claim 13, wherein said virtual client is coupled to said server using a TCPIP tunnel.

15. The apparatus of claim 14, further including means of authentication a user of said device.

16. The apparatus of claim 15, further including means of closing said second software application, after said step launching said first software application.

17. The apparatus of claim 16, wherein said first application is prohibited from accessing a set of files on said device.

18. The apparatus of claim 17, wherein said means of launching a second software application on a server includes means of sending a decryption key to said virtual client.

19. The apparatus of claim 18, wherein a change to said data file by said second application is communicated to said first application.

20. The apparatus of claim 19, wherein said user interface of said virtual client is one of a browser window, a web-based GUI framework, and a client application-based GUI framework.
